(19) United States
(12) Patent Application Publication
(10) Pub. No.: US 2023/0139049 A1
(43) Pub. Date: May 4, 2023

(54) TONER, TONER CARTRIDGE, AND IMAGE FORMING APPARATUS

(71) Applicant: TOSHIBA TEC KABUSHIKI KAISHA, Tokyo (JP)

(72) Inventor: Takumi HATANO, Yokohama Kanagawa (JP)

(73) Assignee: TOSHIBA TEC KABUSHIKI KAISHA, Tokyo (JP)

(21) Appl. No.: 18/092,104

(22) Filed: Dec. 30, 2022

Related U.S. Application Data
(63) Continuation of application No. 17/088,304, filed on Nov. 3, 2020.

(30) Foreign Application Priority Data
Mar. 10, 2020 (JP) 2020-040884

(51) Int. Cl. G03G 9/087; G03G 9/08; G03G 9/107

(52) U.S. Cl. CPC G03G 9/08755; G03G 9/0821; G03G 9/08797; G03G 9/1075

(57) ABSTRACT

According to one embodiment, a toner having excellent heat roller life performance, low-temperature offset resistance, and high-temperature offset resistance, and a toner cartridge and an image forming apparatus, in each of which the toner is stored, are provided.

A toner according to an embodiment contains a colorant, an amorphous polyester resin A, and an amorphous polyester resin B. The amorphous polyester resin A has an Mw_{A} of 0.9×10⁴ to 1.5×10⁴. The amorphous polyester resin B has an Mw_{B} of 4.0×10⁴ to 11.0×10⁴. The amorphous polyester resin A has an Mn_{A} of 3.0×10³ to 4.0×10³. Mw_{A}/Mn_{A} is between 3.1 and 4.0. The amorphous polyester resin B has an Mn_{B} of 2.2×10³ to 3.5×10³. Mw_{B}/Mn_{B} is between 11.4 and 50. The content of the amorphous polyester resin A is between 50 and 60 mass %. The content of the amorphous polyester resin B is between 20 and 30 mass %.

### CROSS-REFERENCE TO RELATED APPLICATION

This application is based upon and claims the benefit of priority from Japanese Patent Application No. 2020-040884, filed on Mar. 10, 2020, the entire contents of which are incorporated herein by reference.

### FIELD

Embodiments described herein relate generally to a toner, a toner cartridge, and an image forming apparatus.

### BACKGROUND

There is known a toner containing a polyester resin. The toner containing a polyester resin can be applied to an image forming apparatus including a fixing device. The fixing device heats the polyester resin in the toner by, for example, a heat roller, and fixes a toner image to a medium such as paper.

A toner containing a crystalline polyester resin is quickly melted by heat of a fixing device and has excellent low-temperature fixability (for example, JP-A-2018-151476). However, in an image forming apparatus including a fixing device, a phenomenon in which a toner image comes in direct contact with a heat roller or a belt, that is, offset is known to occur (JP-A-2006-350302). The toner containing a crystalline polyester resin has excellent low-temperature fixability, and therefore, offset is likely to occur at a high temperature. Therefore, there is room for improvement on the high-temperature offset resistance in the toner containing a crystalline polyester resin.

In addition, a heat roller of a fixing device is maintained at a fixing temperature that is a relatively high temperature for a long period of time during image formation. Therefore, a contact member such as a separation claw or a thermistor that comes in contact with the heat roller is also maintained at a temperature near the fixing temperature.

A crystalline polyester resin has excellent low-temperature fixability, and therefore is likely to be also adhered to the contact member. The crystalline polyester resin adhered to the contact member is subjected to a thermal history due to switching between on and off of a power supply of an image forming apparatus so as to change the melting property.

The crystalline polyester resin subjected to the thermal history increases the viscosity at the fixing temperature and is more likely to be hardened than before being subjected to the thermal history. Therefore, the crystalline polyester resin subjected to the thermal history may damage the surface of the heat roller even at the fixing temperature. As a result, an image defect such as a streak image occurs during image formation. Therefore, there is room for improvement in the toner containing a crystalline polyester resin so as not to damage the surface of the heat roller, that is, so as to improve the heat roller life performance.

As a toner to be applied to an image forming apparatus, a toner containing an amorphous polyester resin is also known (for example, JP-A-2014-118565).

Here, in an image forming apparatus including a fixing device, although depending on the operating conditions of the image forming apparatus, a medium having a narrower width than the width of the heat roller is sometimes used. In a portion coming into contact with the medium having a narrower width during thermal fixing, the temperature of the surface of the heat roller is relatively lowered. On the other hand, both end portions of the heat roller are maintained at a temperature near the fixing temperature without change. As a result, a temperature distribution may occur in the width direction on the surface of the heat roller.

Therefore, the toner is required to hardly cause offset also under a relatively low temperature condition, that is, required to also have low-temperature offset resistance. However, according to the studies made by the present inventor, toner particles containing an amorphous resin described in JP-A-2014-118565 have insufficient low-temperature offset resistance.

### DESCRIPTION OF THE DRAWINGS

FIG. 1 is a diagram showing an example of a schematic structure of an image forming apparatus of an embodiment.

FIG. 2 is a diagram showing an example of a configuration of a fixing device.

### DETAILED DESCRIPTION

An object to be achieved by embodiments is to provide a toner having excellent heat roller life performance, low-temperature offset resistance, and high-temperature offset resistance, and a toner cartridge and an image forming apparatus, in each of which the toner is stored.

A toner of an embodiment contains a colorant, an amorphous polyester resin A, and an amorphous polyester resin B. The amorphous polyester resin A has amass average molecular weight (Mw_{A}) of 0.9×10⁴ to 0.5×10⁴. The amorphous polyester resin B has a mass average molecular weight (Mw_{B}) of 4.0×10⁴ to 11.0×10⁴.

The amorphous polyester resin A has a number average molecular weight (Mn_{A}) of 3.0×10³ to 4.0×10³. The amorphous polyester resin A has a molecular weight distribution (Mw_{A}/Mn_{A}) of 3.1 to 4.0.

The amorphous polyester resin B has a number average molecular weight (Mn_{B}) of 2.2×10³ to 3.5×10³. The amorphous polyester resin B has a molecular weight distribution (Mw_{B}/Mn_{B}) of 11.4 to 50.

The content of the amorphous polyester resin A is between 50 and 60 mass % with respect to 100 mass % of the total amount of the toner. The content of the amorphous polyester resin B is between 20 and 30 mass % with respect to 100 mass % of the total amount of the toner.

Hereinafter, the toner of the embodiment will be described.

The toner of the embodiment contains a colorant, an amorphous polyester resin A, and an amorphous polyester resin B. The toner of the embodiment preferably further contains a crystalline polyester resin C in addition to the colorant, the amorphous polyester resin A, and the amorphous polyester resin B.

The toner of the embodiment may further contain another resin other than the amorphous polyester resin A, the amorphous polyester resin B, and the crystalline polyester resin C within a range not impairing the effect of the embodiment. The toner of the embodiment may further contain an additive as an arbitrary component.

The colorant is described herein.

The colorant is not particularly limited. Examples thereof include carbon black, cyan, yellow, and magenta-based pigments and dyes.

Examples of the carbon black include aniline black, lamp black, acetylene black, furnace black, thermal black, channel black, and Ketjen black.

Examples of the pigments and dyes include Fast Yellow G, benzidine yellow, chrome yellow, quinoline yellow, Indofast Orange, Irgazin Red, Carmine FB, Permanent Bordeaux FRR, Pigment Orange R, Lithol Red 2G, Lake Red C, Rhodamine FB, Rhodamine B Lake, Du Pont Oil Red, Phthalocyanine Blue, Pigment Blue, aniline blue, Calcoil Blue, ultramarine blue, brilliant green B, phthalocyanine green, malachite green oxalate, methylene blue chloride, Rose Bengal, and quinacridone.

Examples of the colorant include C.I. Pigment Black 1, 6, and 7, C.I. Pigment Yellow 1, 12, 14, 17, 34, 74, 83, 97, 155, 180, and 185, C.I. Pigment Orange 48 and 49, C.I. Pigment Red 5, 12, 31, 48, 48:1, 48:2, 48:3, 48:4, 48:5, 49, 53, 53:1, 53:2, 53:3, 57, 57:1, 81, 81:4, 122, 146, 150, 177, 185, 202, 206, 207, 209, 238, and 269, C.I. Pigment Blue 15, 15:1, 15:2, 15:3, 15:4, 15:5, 15:6, 75, 76, and 79, C.I. Pigment Green 1, 7, 8, 36, 42, and 58, C.I. Pigment Violet 1, 19, and 42, and C.I. Acid Red 52, each of which is indicated by the Color Index Number. However, the colorant is not limited to these examples.

As the colorant, any one type may be used by itself or two or more types may be used in combination.

The amorphous polyester resin A is described herein.

The amorphous polyester resin A has a mass average molecular weight (Mw_{A}) of 0.9×10⁴ to 1.5×10⁴, preferably 1 0.1×10⁴ to 1.4×10⁴. Since the Mw_{A} is the above-mentioned lower limit or more, the toner has excellent high-temperature offset resistance. Further, since the Mw_{A} is the above-mentioned upper limit or less, the toner has excellent low-temperature offset resistance and heat roller life performance.

The mass average molecular weight (Mw_{A}) of the amorphous polyester resin A can be measured by GPC (gel permeation chromatography) (“Alliance HPLC” manufactured by Waters Corporation) under the following conditions.
column TSK PWXL+G4000PWXL+G2500PWXL (all manufactured by Tosoh Corporation)
column temperature: 40° C.
detector: RI or UV (210 nm)
eluent: 0.2 mol/L phosphate buffer/acetonitrile=9/1
flow rate: 1.0 mL/min
injection amount: 0.1 mL

The molecular weight of a sample is calculated based on a calibration curve prepared in advance using polyethylene glycol as a reference material.

The amorphous polyester resin A has a number average molecular weight (Mn_{A}) of 3.0×10³ to 4.0×10³, preferably 3.2×10³ to 3.8×10³. Since the Mn_{A} is the above-mentioned lower limit or more, the toner has excellent high-temperature offset resistance. Further, since the Mn_{A} is the above-mentioned upper limit or less, the toner has excellent low-temperature offset resistance and heat roller life performance.

The number average molecular weight (Mn_{A}) of the amorphous polyester resin A can be measured by GPC (gel permeation chromatography) (“Alliance HPLC” manufactured by Waters Corporation) under the following conditions.
column TSK PWXL+G4000PWXL+G2500PWXL (all manufactured by Tosoh Corporation)
column temperature: 40° C.
detector: RI or UV (210 nm)
eluent: 0.2 mol/L phosphate buffer/acetonitrile=9/1
flow rate: 1.0 mL/min
injection amount: 0.1 mL

The molecular weight of a sample is calculated based on a calibration curve prepared in advance using polyethylene glycol as a reference material.

The amorphous polyester resin A has a molecular weight distribution (Mw_{A}/Mn_{A}) of 3.1 to 4.0, preferably 3.2 to 3.7. Since the Mw_{A}/Mn_{A} is the above-mentioned lower limit or more, the toner has excellent low-temperature offset resistance and high-temperature offset resistance. Further, since the Mw_{A}/Mn_{A} is the above-mentioned upper limit or less, the toner has excellent low-temperature offset resistance and high-temperature offset resistance.

The molecular weight distribution (Mw_{A}/Mn_{A}) of the amorphous polyester resin A can be calculated based on the values of Mw_{A} and Mn_{A}.

The glass transition temperature of the amorphous polyester resin A is preferably between 50 and 70° C., more preferably between 55 and 65° C. When the glass transition temperature of the amorphous polyester resin A is the above-mentioned lower limit or higher, the toner has excellent storage stability. When the glass transition temperature of the amorphous polyester resin A is the above-mentioned upper limit or lower, the toner has excellent fixability.

The glass transition temperature of the amorphous polyester resin A can be measured by differential scanning calorimetry.

As the amorphous polyester resin A, an amorphous polyester resin in which the Mw_{A}, Mn_{A}, and Mw_{A}/Mn_{A} are within the predetermined numerical value ranges is selected from various amorphous polyester resins.

As a specific example of the amorphous polyester resin A, a condensation polymer of a dihydric or higher hydric alcohol and a divalent or higher valent carboxylic acid is exemplified.

Examples of the divalent or higher valent carboxylic acid include a divalent or higher valent carboxylic acid, an acid anhydride of a divalent or higher valent carboxylic acid, and an ester of a divalent or higher valent carboxylic acid. Examples of the ester of a divalent or higher valent carboxylic acid include a lower alkyl (C1 to C12) ester of a divalent or higher valent carboxylic acid.

Examples of the dihydric alcohol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, and an alkylene oxide adduct of bisphenol A. However, the dihydric alcohol is not limited to these examples.

Examples of the alkylene oxide adduct of bisphenol A include a compound obtained by adding 1 to 10 moles on the average of an alkylene oxide having 2 to 3 carbon atoms to bisphenol A. Examples of the alkylene oxide adduct of bisphenol A include polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane.

As the dihydric alcohol, an alkylene oxide adduct of bisphenol A is preferred. As the dihydric alcohol, any one type may be used by itself or two or more types may be used in combination.

Examples of the trihydric or higher hydric alcohol include sorbitol, 1,2,3,6-hexatetrol, 1,4-sorbitan, pentaerythritol, dipentaerythritol, tripentaerythritol, 1,2,4-butanetriol, 1,2,5-pentanetriol, glycerol, 2-methyl propanetriol, 2-methyl-1,2,4-butanetriol, trimethylol ethane, trimethylol propane, and 1,3,5-trihydroxymethylbenzene. However, the trihydric or higher hydric alcohol is not limited to these examples.

As the trihydric or higher hydric alcohol, sorbitol, 1,4-sorbitan, pentaerythritol, glycerol, or trimethylol propane is preferred. As the trihydric or higher hydric alcohol, anyone type may be used by itself or two or more types may be used in combination.

Examples of the divalent carboxylic acid include maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, and succinic acid substituted with an alkyl group or an alkenyl group. However, the divalent carboxylic acid is not limited to these examples.

Examples of the succinic acid substituted with an alkyl group or an alkenyl group include succinic acid substituted with an alkyl group or an alkenyl group having 2 to 20 carbon atoms. For example, n-dodecenyl succinic acid, n-dodecyl succinic acid, and the like are exemplified. Further, an acid anhydride of the above-mentioned divalent carboxylic acid or an ester of the above-mentioned divalent carboxylic acid may be used.

As the divalent carboxylic acid, maleic acid, fumaric acid, terephthalic acid, or succinic acid substituted with an alkenyl group having 2 to 20 carbon atoms is preferred. As the divalent carboxylic acid, anyone type may be used by itself or two or more types may be used in combination.

Examples of the trivalent or higher valent carboxylic acid include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, enpol trimer acid, acid anhydrides thereof or esters thereof. However, the trivalent or higher valent carboxylic acid is not limited to these examples.

As the trivalent or higher valent carboxylic acid, 1,2,4-benzenetricarboxylic acid (trimellitic acid), an acid anhydride thereof, or a lower alkyl (C1 to C12) ester thereof is preferred.

As the trivalent or higher valent carboxylic acid, any one type may be used by itself or two or more types may be used in combination.

The amorphous polyester resin may be sulfonated. For example, a metal salt or an alkali salt of an alkali sulfonated polyester resin, or the like is exemplified.

When the dihydric or higher hydric alcohol and the divalent or higher valent carboxylic acid are subjected to condensation polymerization, a commonly used catalyst may be used for accelerating the reaction. Examples of the catalyst include dibutyltin oxide, a titanium compound, dialkoxytin(II), tin(II) oxide, fatty acid tin(II), tin(II) dioctanoate, and tin(II) distearate.

The amorphous polyester resin B is described herein.

The amorphous polyester resin B has a mass average molecular weight (Mw_{B}) of 4.0×10⁴ to 11.0×10⁴, preferably 4.5×10⁴ to 9.0×10⁴. Since the MW_{B} is the above-mentioned lower limit or more, the toner has excellent high-temperature offset resistance. Further, since the Mw_{B} is the above-mentioned upper limit or less, the toner has excellent low-temperature offset resistance and heat roller life performance.

The mass average molecular weight (Mw_{B}) of the amorphous polyester resin B can be measured by GPC (gel permeation chromatography) (“Alliance HPLC” manufactured by Waters Corporation) under the following conditions.
column TSK PWXL+G4000PWXL+G2500PWXL (all manufactured by Tosoh Corporation)
column temperature: 40° C.
detector: RI or UV (210 nm)
eluent: 0.2 mol/L phosphate buffer/acetonitrile=9/1
flow rate: 1.0 mL/min
injection amount: 0.1 mL

The molecular weight of a sample is calculated based on a calibration curve prepared in advance using polyethylene glycol as a reference material.

The amorphous polyester resin B has a number average molecular weight (Mn_{B}) of 2 0.2×10³ to 3.5×10³, preferably 2.5×10³ to 3.1×10³.

Since the Mn_{B} is the above-mentioned lower limit or more, the toner has excellent high-temperature offset resistance. Further, since the Mn_{B} is the above-mentioned upper limit or less, the toner has excellent low-temperature offset resistance and heat roller life performance.

The number average molecular weight (Mn_{B}) of the amorphous polyester resin B can be measured by GPC (gel permeation chromatography) (“Alliance HPLC” manufactured by Waters Corporation) under the following conditions.
column TSK PWXL+G4000PWXL+G2500PWXL (all manufactured by Tosoh Corporation)
column temperature: 40° C.
detector: RI or UV (210 nm)
eluent: 0.2 mol/L phosphate buffer/acetonitrile=9/1
flow rate: 1.0 mL/min
injection amount: 0.1 mL

The molecular weight of a sample is calculated based on a calibration curve prepared in advance using polyethylene glycol as a reference material.

The amorphous polyester resin B has a molecular weight distribution (Mw_{B}/Mn_{B}) of 11.4 to 50, preferably 14.5 to 36.

Since the Mw_{B}/Mn_{B} is the above-mentioned lower limit or more, the toner has excellent low-temperature offset resistance and high-temperature offset resistance. Further, since the Mw_{B}/Mn_{B} is the above-mentioned upper limit or less, the toner has excellent low-temperature offset resistance and high-temperature offset resistance.

The molecular weight distribution (Mw_{B}/Mn_{B}) of the amorphous polyester resin B can be calculated based on the values of Mw_{B} and Mn_{B}.

The glass transition temperature of the amorphous polyester resin B is preferably between 45 and 65° C., more preferably between 52 and 60° C. When the glass transition temperature of the amorphous polyester resin B is the above-mentioned lower limit or higher, the toner has excellent storage stability. When the glass transition temperature of the amorphous polyester resin B is the above-mentioned upper limit or lower, the toner has excellent fixability.

The glass transition temperature of the amorphous polyester resin B can be measured by differential scanning calorimetry.

An illustrative example of the amorphous polyester resin B is the same as the contents described with respect to the specific example of the amorphous polyester resin A. An amorphous polyester resin in which the Mw_{B}, Mn_{B}, and Mw_{B}/Mn_{B} are within the predetermined numerical value ranges is selected from the amorphous polyester resins exemplified as the specific example of the amorphous polyester resin A.

The crystalline polyester resin C is described herein.

When the toner contains the crystalline polyester resin C, the toner has excellent low-temperature fixability. In the embodiment, the crystalline polyester resin is a polyester resin in which the ratio of the softening point to the melting temperature (softening point/melting temperature) is between 0.8 and 1.2. The amorphous polyester resin is a polyester resin in which the ratio of the softening point to the melting temperature is less than 0.8 or more than 1.2.

As the crystalline polyester resin C, for example, a condensation polymer of a dihydric or higher hydric alcohol and a divalent or higher valent carboxylic acid is exemplified.

Examples of the dihydric or higher hydric alcohol include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane. As the dihydric or higher hydric alcohol, 1,4-butanediol or 1,6-hexanediol is preferred.

Examples of the divalent or higher valent carboxylic acid include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, succinic acid substituted with an alkyl group or an alkenyl group, cyclohexane dicarboxylic acid, trimellitic acid, pyromellitic acid, and acid anhydrides thereof or esters thereof. Examples of the succinic acid substituted with an alkyl group or an alkenyl group include succinic acid substituted with an alkyl group or an alkenyl group having 2 to 20 carbon atoms. For example, n-dodecenyl succinic acid, n-dodecyl succinic acid, and the like are exemplified. Among these, fumaric acid is preferred. However, the crystalline polyester resin C is not limited to these examples. As the crystalline polyester resin C, anyone type may be used by itself or two or more types may be used in combination.

The crystalline polyester resin C has a mass average molecular weight (Mw_{C}) of preferably 7.0×10³ to 12.0×10³, more preferably 8.5×10³ to 11.0×10³. When the Mw_{C} is the above-mentioned lower limit or more, the toner has further excellent low-temperature fixability. Further, when the Mw_{C} is the above-mentioned upper limit or less, the toner has excellent stability during storage and low-temperature offset resistance.

The crystalline polyester resin C has a number average molecular weight (Mn_{C})_{C} of preferably 7.0×10³ to 12.0×10³, more preferably 8.5×10³ to 11.0×10³. When the Mn_{C} is the above-mentioned lower limit or more, the toner has further excellent low-temperature fixability. Further, when the Mn_{C} is the above-mentioned upper limit or less, the toner has excellent stability during storage and low-temperature offset resistance.

The crystalline polyester resin C has a molecular weight distribution (Mw_{C}/Mn_{C}) of preferably 7.0×10³ to 12.0×10³, more preferably 8.5×10³ to 11.0×10³. When the Mw_{C}/Mn_{C} is the above-mentioned lower limit or more, the toner has further excellent low-temperature offset resistance and high-temperature offset resistance. Further, when the Mw_{C}/Mn_{C} is the above-mentioned upper limit or less, the toner has excellent low-temperature offset resistance and high-temperature offset resistance.

Another resin is described herein.

The toner of the embodiment may further contain another resin other than the amorphous polyester resin A, the amorphous polyester resin B, and the crystalline polyester resin C within a range where the effect of the embodiment is obtained. In that case, such another resin functions as a binder resin.

Examples of such another resin include various resins to be used as a binder resin for a toner such as a styrene-based resin, an ethylene-based resin, an acrylic resin, a phenolic resin, an epoxy-based resin, an allyl phthalate-based resin, a polyamide-based resin, and a maleic acid-based resin. However, such another binder resin is not limited to these examples. As such another resin, any one type may be used by itself or two or more types may be used in combination.

Such another resin is obtained by polymerization using one type or a plurality of types of vinyl polymerizable monomers, for example, aromatic vinyl monomers such as styrene, methylstyrene, methoxystyrene, phenyl styrene, and chlorostyrene; ester-based monomers such as methyl acrylate, ethyl acrylate, butyl acrylate, methyl methacrylate, ethyl methacrylate, and butyl methacrylate; carboxylic acid-containing monomers such as acrylic acid, methacrylic acid, fumaric acid, and maleic acid; amine-based monomers such as amino acrylate, acrylamide, methacrylamide, vinylpyridine, and vinylpyrrolidone; and derivatives thereof, and the like.

Such another resin is also obtained by polycondensation of a polycondensation polymerizable monomer composed of an alcohol component and a carboxylic acid component. In the polymerization of the polymerizable monomer, any of various auxiliary agents to be used in polymerization of a binder resin such as a chain transfer agent, a crosslinking agent, a polymerization initiator, a surfactant, an aggregating agent, a pH adjusting agent, and an anti-foaming agent can be used.

The toner of the embodiment may further contain an additive other than the colorant, the amorphous polyester resin A, the amorphous polyester resin B, and the crystalline polyester resin C.

Examples of the additive include various additives such as a charge control agent, a release agent, and an antioxidant. However, the additive is not limited to these examples. As the additive, any one type may be used by itself or two or more types may be used in combination.

As the release agent, an ester wax is preferred from the viewpoint that the toner has further excellent storage stability. The ester wax can be synthesized from, for example, a long-chain alkyl carboxylic acid and a long-chain alkyl alcohol by an esterification reaction. Examples of the long-chain alkyl carboxylic acid include palmitic acid, stearic acid, arachidonic acid, behenic acid, lignoceric acid, cerotic acid, and montanic acid. Examples of the long-chain alkyl alcohol include palmityl alcohol, stearyl alcohol, arachidyl alcohol, behenyl alcohol, lignoceryl alcohol, ceryl alcohol, and montanyl alcohol.

The composition of the toner is described herein.

The content of the amorphous polyester resin A is between 50 and 60 mass %, preferably between 52 and 58 mass % with respect to 100 mass % of the total amount of the toner. Since the content of the amorphous polyester resin A is the above-mentioned lower limit or more, the toner has excellent low-temperature fixability, low-temperature offset resistance, and heat roller life performance. Further, since the content of the amorphous polyester resin A is the above-mentioned upper limit or less, the toner has excellent high-temperature offset resistance.

The content of the amorphous polyester resin B is between 20 and 30 mass %, preferably between 23 and 28 mass % with respect to 100 mass % of the total amount of the toner. Since the content of the amorphous polyester resin B is the above-mentioned lower limit or more, the toner has excellent high-temperature offset resistance. Further, since the content of the amorphous polyester resin B is the above-mentioned upper limit or less, the toner has excellent low-temperature fixability, low-temperature offset resistance, and heat roller life performance.

The content of the colorant is preferably between 3 and 10 mass %, more preferably between 4 and 8 mass %. When the content of the colorant is the above-mentioned lower limit or more, the toner has excellent color reproducibility. Further, when the content of the colorant is the above-mentioned upper limit or less, the dispersibility of the colorant is excellent, and the toner has excellent low-temperature fixability.

When the toner contains the crystalline polyester resin C, the content of the crystalline polyester resin C is preferably between 3 and 20 mass %, more preferably between 5 and 15 mass % with respect to 100 mass % of the total amount of the toner. When the content of the crystalline polyester resin C is the above-mentioned lower limit or more, the toner has further excellent low-temperature fixability. Further, when the content of the crystalline polyester resin C is the above-mentioned upper limit or less, the toner has further excellent low-temperature offset resistance and high-temperature offset resistance.

A method for producing a toner is described herein.

The toner of the embodiment can be produced by, for example, a kneading and pulverization method or a chemical method. The toner produced by a kneading and pulverization method, a chemical method, or the like may be used as a toner as it is, or may be mixed with an external additive as needed and used as a toner.

The kneading and pulverization method is described herein.

As the kneading and pulverization method, for example, a production method including a mixing step, a kneading step, and a pulverization step described below is exemplified. The kneading and pulverization method may further include a classification step described below.
Mixing step: a step of mixing a colorant, an amorphous polyester resin A, an amorphous polyester resin B, and the like, thereby obtaining a mixture
Kneading step: a step of melt-kneading the mixture, thereby obtaining a kneaded material
Pulverization step: a step of pulverizing the kneaded material, thereby obtaining a pulverized material
Classification step: a step of classifying the pulverized material

In the mixing step, the raw materials of the toner are mixed, thereby forming a mixture. A mixer to be used in the mixing step is not particularly limited. In the mixing step, a crystalline polyester resin C, another resin, or an additive may be used as needed.

In the kneading step, the mixture formed in the mixing step is melt-kneaded, thereby forming a kneaded material. A kneader to be used in the kneading step is not particularly limited.

In the pulverization step, the kneaded material formed in the kneading step is pulverized, thereby forming a pulverized material. As a pulverizer to be used in the pulverization step, various pulverizers such as a hammer mill can be used. Further, the pulverized material obtained by the pulverizer may be further finely pulverized. As a pulverizer that further finely pulverizes the pulverized material, various pulverizers can be used. The pulverized material obtained by the pulverization step may be used as a toner as it is, or may be subjected to the classification step as needed and used as a toner.

In the classification step, the pulverized material obtained in the pulverization step is classified. A classifier to be used in the classification step is not particularly limited.

The chemical method is described herein. In the chemical method, a colorant, an amorphous polyester resin A, an amorphous polyester resin B, and the like are mixed, thereby forming a mixture. Subsequently, the mixture is melt-kneaded, thereby forming a kneaded material. Subsequently, the kneaded material is pulverized, thereby forming coarsely granulated moderately pulverized particles. Subsequently, the moderately pulverized particles are mixed with an aqueous medium, thereby preparing a mixed liquid. Subsequently, the mixed liquid is subjected to mechanical shearing, thereby forming a fine particle dispersion liquid. Finally, the fine particles are aggregated in the fine particle dispersion liquid, thereby forming a toner.

The external additive is described herein.

The external additive is added so that the toner has excellent fluidity, chargeability, and stability during storage. Examples of the external additive include particles composed of an inorganic oxide. Examples of the inorganic oxide include silica, titania, alumina, strontium titanate, and tin oxide. Further, the particles composed of the inorganic oxide may be subjected to a surface treatment with a hydrophobizing agent from the viewpoint of improvement of stability. As the external additive, anyone type may be used by itself or two or more types may be used in combination.

The volume average particle diameter of a particle group of the particles composed of the inorganic oxide is not particularly limited, but is preferably, for example, in a range of 8 to 200 nm. When the volume average particle diameter of the particle group of the particles composed of the inorganic oxide is less than the above lower limit, the transfer efficiency of the toner to a transfer belt or paper may be deteriorated. When the volume average particle diameter of the particle group of the particles exceeds the above upper limit, a photoconductive body may be damaged.

The addition amount of the external additive is not particularly limited, but is preferably in a range of 0.2 to 8.0 mass % with respect to the total mass of the toner. To the toner, in addition to the particles composed of the inorganic oxide, resin fine particles with a size of 1 μm or less may be further added.

A method for adding the external additive will be described.

The external additive is, for example, mixed with the toner by a mixer. Examples of the mixer include the same mixers as used in the mixing step of the kneading and pulverization method.

The external additive may be sieved to separate coarse particles, etc. as needed using a sieving device. The sieving device is not particularly limited, and various sieving devices can be used.

Hereinafter, a toner cartridge of an embodiment is described herein.

In the toner cartridge of the embodiment, the toner of the above-mentioned embodiment is stored. For example, the toner cartridge includes a container, and the toner of the embodiment is stored in the container. The container is not particularly limited, and various containers that can be applied to an image forming apparatus can be used.

The toner of the embodiment may be used as a one-component developer or may be combined with a carrier and used as a two-component developer.

Hereinafter, an image forming apparatus of an embodiment is described herein with reference to the drawings.

In the image forming apparatus of the embodiment, the toner of the above-mentioned embodiment is stored in an apparatus body. As the apparatus body, a general electrophotographic apparatus can be used.

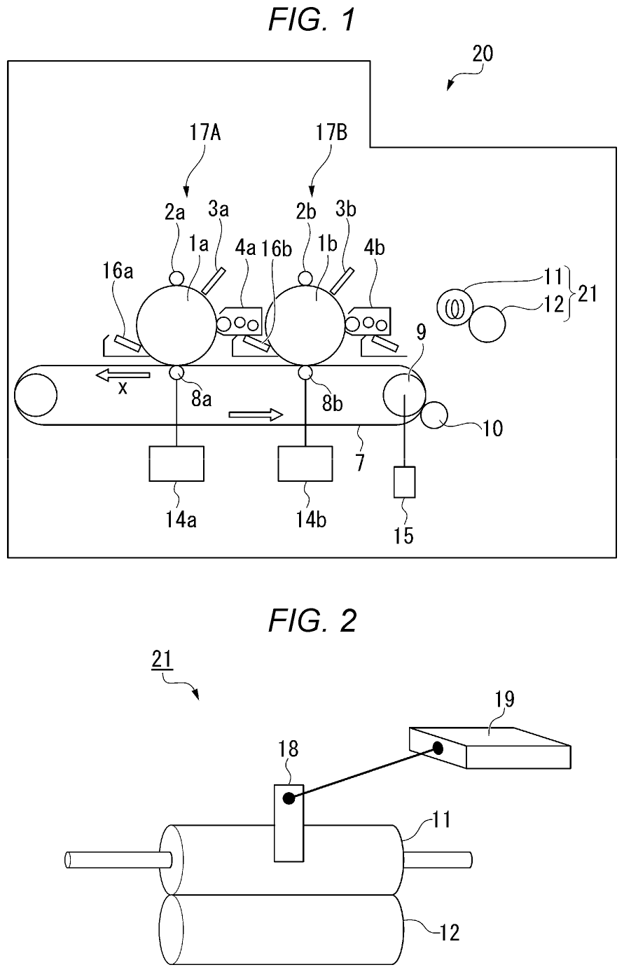

FIG. 1 is a view showing an example of a schematic structure of the image forming apparatus of the embodiment.

An image forming apparatus 20 has an apparatus body including an intermediate transfer belt 7, and a first image forming unit 17A and a second image forming unit 17B provided in this order on the intermediate transfer belt 7, and a fixing device 21 provided downstream thereof. Along the running direction X of the intermediate transfer belt 7, that is, along the progress direction of the image forming process, the first image forming unit 17A is provided downstream of the second image forming unit 17B. The fixing device 21 is provided downstream of the first image forming unit 17A.

The first image forming unit 17A includes a photoconductive drum 1a, a cleaning device 16a, a charging device 2a, a light exposure device 3a, a first developing device 4a, and a primary transfer roller 8a. The cleaning device 16a, the charging device 2a, the light exposure device 3a, and the first developing device 4a are provided in this order along the rotational direction of the photoconductive drum 1a. The primary transfer roller 8a is provided on the photoconductive drum 1a through the intermediate transfer belt 7 so as to face the photoconductive drum 1a.

The second image forming unit 17B includes a photoconductive drum 1b, a cleaning device 16b, a charging device 2b, a light exposure device 3b, a second developing device 4b, and a primary transfer roller 8b. The cleaning device 16b, the charging device 2b, the light exposure device 3b, and the second developing device 4b are provided in this order along the rotational direction of the photoconductive drum 1b. The primary transfer roller 8b is provided on the photoconductive drum 1b through the intermediate transfer belt 7 so as to face the photoconductive drum 1b.

In the first developing device 4a and in the second developing device 4b, the toner of the above-mentioned embodiment is stored. The toner may be configured to be supplied from a toner cartridge (not shown).

To the primary transfer roller 8a, a primary transfer power supply 14a is connected. To the primary transfer roller 8b, a primary transfer power supply 14b is connected.

Downstream of the first image forming unit 17A, a secondary transfer roller 9 and a backup roller 10 are disposed so as to face each other through the intermediate transfer belt 7. To the secondary transfer roller 9, a secondary transfer power supply 15 is connected.

The fixing device 21 includes a heat roller 11 and a press roller 12 disposed so as to face each other. A heat source 5 is inserted in a central portion of a roller of the heat roller 11. The heat source 5 is a heat source of the heat roller 11. A toner image is fixed to paper by heating and pressing using the heat roller 11 and the press roller 12.

FIG. 2 is a diagram showing an example of a configuration of the fixing device 21. As shown in FIG. 2, a thermistor 18 is in contact with the heat roller 11. The thermistor 18 is electrically connected to a temperature control device 19. Therefore, in the fixing device 21, the temperature of the heat roller 11 can be monitored by the thermistor 18 and controlled within a fixed temperature range by the temperature control device 19.

By the image forming apparatus 20, image formation is performed, for example, as follows.

First, by the charging device 2b, the photoconductive drum 1b is uniformly charged. Subsequently, by the light exposure device 3b, light exposure is performed, whereby an electrostatic latent image is formed. Subsequently, the electrostatic latent image is developed using the toner of the embodiment supplied from the developing device 4b, whereby a second toner image is obtained.

Subsequently, by the charging device 2a, the photoconductive drum 1a is uniformly charged. Subsequently, by the light exposure device 3a, light exposure is performed based on the first image information (second toner image), whereby an electrostatic latent image is formed. Subsequently, the electrostatic latent image is developed using the toner of the embodiment supplied from the developing device 4a, whereby a first toner image is obtained.

The second toner image and the first toner image are transferred in this order onto the intermediate transfer belt 7 using the primary transfer rollers 8a and 8b.

An image in which the second toner image and the first toner image are stacked in this order on the intermediate transfer belt 7 is secondarily transferred onto a recording medium (not shown) through the secondary transfer roller 9 and the backup roller 10. By doing this, an image in which the first toner image and the second toner image are stacked in this order is formed on the recording medium.

The developer containing the toner of the embodiment may be applied in the image forming apparatus shown in FIG. 1. The image forming apparatus shown in FIG. 1 is configured to fix a toner image, but is not limited to this configuration, and may be an inkjet type apparatus.

The toner of at least one embodiment described above has excellent heat roller life performance, low-temperature offset resistance, and high-temperature offset resistance.

### EXAMPLES

Hereinafter, embodiments will be more specifically described by showing Examples.

The amorphous polyester resins A used in Examples are as follows. The following amorphous polyester resins A were obtained by performing condensation polymerization of an acid component and an alcohol component and adjusting the mass average molecular weight, the number average molecular weight, and the molecular weight distribution.

amorphous polyester resin A1 (mass average molecular weight (Mw_{A}): 1.2×10⁴, number average molecular weight (Mn_{A}): 3.5×10³, Mw_{A}/Mn_{A}: 3.43)

amorphous polyester resin A2 (mass average molecular weight (Mw_{A}): 0.9×10⁴, number average molecular weight (Mn_{A}): 3.0×10³, Mw_{A}/Mn_{A}: 3.0)

amorphous polyester resin A3 (mass average molecular weight (Mw_{A}): 1.5×10⁴, number average molecular weight (Mn_{A}): 3.9×10³, Mw_{A}/Mn_{A}: 3.85)

amorphous polyester resin A4 (mass average molecular weight (Mw_{A}): 0.8×10⁴, number average molecular weight (Mn_{A}): 2.8×10³, Mw_{A}/Mn_{A}: 2.86)

amorphous polyester resin A5 (mass average molecular weight (Mw_{A}): 1.6×10⁴, number average molecular weight (Mn_{A}): 4.1×10³, Mw_{A}/Mn_{A}: 3.90)

The amorphous polyester resins B used in Examples are as follows. The following amorphous polyester resins B were obtained by performing condensation polymerization of an acid component and an alcohol component and adjusting the mass average molecular weight, the number average molecular weight, and the molecular weight distribution.

amorphous polyester resin B1 (mass average molecular weight (Mw_{B}): 7.1×10⁴, number average molecular weight (Mn_{B}): 2.8×10³, Mw_{B}/Mn_{B}: 25.4)

amorphous polyester resin B2 (mass average molecular weight (Mw_{B}): 4.0×10⁴, number average molecular weight (Mn_{B}): 2.2×10³, Mw_{B}/Mn_{B}: 18.2)

amorphous polyester resin B3 (mass average molecular weight (Mw_{B}): 11.0×10⁴, number average molecular weight (Mn_{B}): 3.5×10³, Mw_{B}/Mn_{B}: 31.4)

amorphous polyester resin B4 (mass average molecular weight (Mw_{B}): 13.0×10⁴, number average molecular weight (Mn_{B}): 4.0×10³, Mw_{B}/Mn_{B}: 32.5)

amorphous polyester resin B5 (mass average molecular weight (Mw_{B}): 3.1×10⁴, number average molecular weight (Mn_{B}): 2.0×10³, Mw_{B}/Mn_{B}: 15.5)

The crystalline polyester resin C used in Examples is as follows. The following crystalline polyester resin C was obtained by performing condensation polymerization of an acid component and an alcohol component and adjusting the mass average molecular weight, the number average molecular weight, and the molecular weight distribution.

crystalline polyester resin C1 (mass average molecular weight (Mw_{C}): 9.5×10³, number average molecular weight (Mn_{C}): 2.2×10³, Mw_{C}/Mn_{C}: 4.32)

The additives used in Examples are as follows.

ester wax: Nissan Electol WEP-3, NOF Corporation

carbon black: #44, Mitsubishi Chemical Corporation

A method for evaluating the viscosity will be described.

With respect to the toner of each example, the viscosity was measured under the following conditions using a flow tester CFT500D manufactured by Shimadzu Corporation.

Temperature raising rate: 2.5° C./min; test load: 10 Kg; preheat time: 300 sec; die hole diameter: 1.0 mm; die length: 1.0 mm

The viscosity was evaluated according to the following criteria based on the measurement results of the viscosity.

good: The viscosity is 1.0×10⁴ Pa·s or less.

poor: The viscosity exceeds 1 0.0×10⁴ Pa·s.

A method for evaluating the heat roller life performance will be described.

By using MFP e-studio 5008A manufactured by Toshiba Corporation in which the toner of each example was stored, paper feeding was performed at a printing ratio of 8%. The temperature at printing was set to 160° C. The material of the heat roller of MFP e-studio 5008A is PTFE.

The paper feeding was performed while confirming damage to the heat roller, and the heat roller life performance was evaluated according to the following criteria based on the number of sheets of paper fed when damage occurred in the heat roller.

good: The number of sheets of paper fed when damage occurred in the heat roller is 450×10³ or more.

fair: The number of sheets of paper fed when damage occurred in the heat roller is 330×10³ or more and less than 450×10³.

poor: The number of sheets of paper fed when damage occurred in the heat roller is less than 330×10³.

A method for evaluating the low-temperature offset resistance will be described.

By using MFP e-studio 5008A manufactured by Toshiba Corporation, the temperature at printing was gradually lowered. The temperature when offset occurred was recorded, and the low-temperature offset resistance was evaluated based on the following criteria.

good: The temperature when offset occurred is 120° C. or lower.

fair: The temperature when offset occurred is 130° C. or lower.

poor: The temperature when offset occurred is higher than 130° C.

A method for evaluating the high-temperature offset resistance will be described.

By using MFP e-studio 5008A manufactured by Toshiba Corporation, the temperature at printing was gradually raised. The temperature when offset occurred was recorded, and the high-temperature offset resistance was evaluated based on the following criteria.

good: The temperature when offset occurred is 200° C. or higher.

fair: The temperature when offset occurred is 190° C. or higher.

poor: The temperature when offset occurred is lower than 190° C.

### Example 1

The toner raw materials were placed in a Henschel mixer (manufactured by Mitsui Mining Co., Ltd.) and mixed. The composition of the toner raw materials is shown below.

| | | |
|---|---|---|
| amorphous polyester resin A1 | 55 | parts |
| amorphous polyester resin B1 | 25 | parts |
| crystalline polyester resin C1 | 10 | parts |
| ester wax | 5 | parts |
| carbon black | 5 | parts |

The mixture of the toner raw materials was melt-kneaded using a twin-screw extruder. The resulting melt-kneaded material was cooled, and then, coarsely pulverized using a hammer mill. The coarsely pulverized material was finely pulverized using a jet pulverizer. The finely pulverized material was classified, whereby toner base was obtained. The mass average particle diameter of the toner base was 8.5 μm. To the toner base, 1.5 mass % of hydrophobic silica and 0.4 mass % of titanium oxide were added, whereby a toner of Example 1 was produced.

The temperature at which low-temperature offset occurred was 125° C. The temperature at which high-temperature offset occurred was 195° C. The viscosity of the toner after the toner was left in an environment at 160° C. for 24 hours was 0.8×10⁴ Pas. The number of sheets of paper fed when damage occurred in the heat roller was 390×10³.

### Example 2

A toner of Example 2 was produced in the same manner as in Example 1 except that the composition of the toner raw materials was changed as follows.

| | |
|---|---|
| amorphous polyester resin A2 | 55 parts |
| amorphous polyester resin B2 | 25 parts |
| crystalline polyester resin C1 | 10 parts |
| ester wax | 5 parts |
| carbon black | 5 parts |

The temperature at which low-temperature offset occurred was 118° C. The temperature at which high-temperature offset occurred was 195° C. The viscosity of the toner after the toner was left in an environment at 160° C. for 24 hours was 0.7×10⁴ Pas. The number of sheets of paper fed when damage occurred in the heat roller was 460×10³.

### Example 3

A toner of Example 3 was produced in the same manner as in Example 1 except that the composition of the toner raw materials was changed as follows.

| | |
|---|---|
| amorphous polyester resin A3 | 55 parts |
| amorphous polyester resin B3 | 25 parts |
| crystalline polyester resin C1 | 10 parts |
| ester wax | 5 parts |
| carbon black | 5 parts |

The temperature at which low-temperature offset occurred was 127° C. The temperature at which high-temperature offset occurred was 205° C. The viscosity of the toner after the toner was left in an environment at 160° C. for 24 hours was 0.8×10⁴ Pas. The number of sheets of paper fed when damage occurred in the heat roller was 360×10³.

### Example 4

A toner of Example 4 was produced in the same manner as in Example 1 except that the composition of the toner raw materials was changed as follows.

| | |
|---|---|
| amorphous polyester resin A1 | 60 parts |
| amorphous polyester resin B2 | 20 parts |
| crystalline polyester resin C1 | 10 parts |
| ester wax | 5 parts |
| carbon black (#44, Mitsubishi | 5 parts |
| Chemical Corporation | |

The temperature at which low-temperature offset occurred was 116° C. The temperature at which high-temperature offset occurred was 193° C. The viscosity of the toner after the toner was left in an environment at 160° C. for 24 hours was 0.7×10⁴ Pas. The number of sheets of paper fed when damage occurred in the heat roller was 340×10³.

### Example 5

A toner of Example 5 was produced in the same manner as in Example 1 except that the composition of the toner raw materials was changed as follows.

| | |
|---|---|
| amorphous polyester resin A2 | 50 parts |
| amorphous polyester resin B3 | 30 parts |
| crystalline polyester resin C1 | 10 parts |
| ester wax | 5 parts |
| carbon black | 5 parts |

The temperature at which low-temperature offset occurred was 128° C. The temperature at which high-temperature offset occurred was 210° C. The viscosity of the toner after the toner was left in an environment at 160° C. for 24 hours was 1.0×10⁴ Pas. The number of sheets of paper fed when damage occurred in the heat roller was 390×10³.

### Example 6

A toner of Example 6 was produced in the same manner as in Example 1 except that the composition of the toner raw materials was changed as follows.

| | |
|---|---|
| amorphous polyester resin A2 | 60 parts |
| amorphous polyester resin Bl | 20 parts |
| crystalline polyester resin C1 | 10 parts |
| ester wax | 5 parts |
| carbon black | 5 parts |

The temperature at which low-temperature offset occurred was 123° C. The temperature at which high-temperature offset occurred was 197° C. The viscosity of the toner after the toner was left in an environment at 160° C. for 24 hours was 0.7×10⁴ Pas. The number of sheets of paper fed when damage occurred in the heat roller was 460×10³.

### Example 7

A toner of Example 7 was produced in the same manner as in Example 1 except that the composition of the toner raw materials was changed as follows.

| | |
|---|---|
| amorphous polyester resin A3 | 50 parts |
| amorphous polyester resin Bl | 30 parts |
| crystalline polyester resin C1 | 10 parts |
| ester wax | 5 parts |
| carbon black | 5 parts |

The temperature at which low-temperature offset occurred was 124° C. The temperature at which high-temperature offset occurred was 196° C. The viscosity of the toner after the toner was left in an environment at 160° C. for 24 hours was 1.0×10⁴ Pas. The number of sheets of paper fed when damage occurred in the heat roller was 460×10³.

### Comparative Example 1

A toner of Comparative Example 1 was produced in the same manner as in Example 1 except that the composition of the toner raw materials was changed as follows.

| | |
|---|---|
| amorphous polyester resin A4 | 60 parts |
| amorphous polyester resin B1 | 20 parts |
| crystalline polyester resin C1 | 10 parts |
| ester wax | 5 parts |
| carbon black | 5 parts |

The temperature at which low-temperature offset occurred was 113° C. The temperature at which high-temperature offset occurred was 185° C. The viscosity of the toner after the toner was left in an environment at 160° C. for 24 hours was 0.7×10⁴ Pas. The number of sheets of paper fed when damage occurred in the heat roller was 410×10³.

### Comparative Example 2

A toner of Comparative Example 2 was produced in the same manner as in Example 1 except that the composition of the toner raw materials was changed as follows.

| | |
|---|---|
| amorphous polyester resin A5 | 50 parts |
| amorphous polyester resin B1 | 30 parts |
| crystalline polyester resin C1 | 10 parts |
| ester wax | 5 parts |
| carbon black | 5 parts |

The temperature at which low-temperature offset occurred was 140° C. The temperature at which high-temperature offset occurred was 195° C. The viscosity of the toner after the toner was left in an environment at 160° C. for 24 hours was 1.5×10⁴ Pas. The number of sheets of paper fed when damage occurred in the heat roller was 260×10³.

### Comparative Example 3

A toner of Comparative Example 3 was produced in the same manner as in Example 1 except that the composition of the toner raw materials was changed as follows.

| | |
|---|---|
| amorphous polyester resin A1 | 50 parts |
| amorphous polyester resin B4 | 30 parts |
| crystalline polyester resin C1 | 10 parts |
| ester wax | 5 parts |
| carbon black | 5 parts |

The temperature at which low-temperature offset occurred was 135° C. The temperature at which high-temperature offset occurred was 205° C. The viscosity of the toner after the toner was left in an environment at 160° C. for 24 hours was 2.0×10⁴ Pas. The number of sheets of paper fed when damage occurred in the heat roller was 180×10³.

### Comparative Example 4

A toner of Comparative Example 4 was produced in the same manner as in Example 1 except that the composition of the toner raw materials was changed as follows.

| | |
|---|---|
| amorphous polyester resin A1 | 60 parts |
| amorphous polyester resin B5 | 20 parts |
| crystalline polyester resin C1 | 10 parts |
| ester wax | 5 parts |
| carbon black | 5 parts |

The temperature at which low-temperature offset occurred was 128° C. The temperature at which high-temperature offset occurred was 175° C. The viscosity of the toner after the toner was left in an environment at 160° C. for 24 hours was 0.6×10⁴ Pas. The number of sheets of paper fed when damage occurred in the heat roller was 460×10³.

### Comparative Example 5

A toner of Comparative Example 5 was produced in the same manner as in Example 1 except that the composition of the toner raw materials was changed as follows.

| | |
|---|---|
| amorphous polyester resin A1 | 45 parts |
| amorphous polyester resin B1 | 35 parts |
| crystalline polyester resin C1 | 10 parts |
| ester wax | 5 parts |
| carbon black | 5 parts |

The temperature at which low-temperature offset occurred was 140° C. The temperature at which high-temperature offset occurred was 210° C. The viscosity of the toner after the toner was left in an environment at 160° C. for 24 hours was 9.0×10⁴ Pas. The number of sheets of paper fed when damage occurred in the heat roller was 120×10³.

### Comparative Example 6

A toner of Comparative Example 6 was produced in the same manner as in Example 1 except that the composition of the toner raw materials was changed as follows.

| | |
|---|---|
| amorphous polyester resin A1 | 65 parts |
| amorphous polyester resin B1 | 15 parts |
| crystalline polyester resin C1 | 10 parts |
| ester wax | 5 parts |
| carbon black | 5 parts |

The temperature at which low-temperature offset occurred was 123° C. The temperature at which high-temperature offset occurred was 165° C. The viscosity of the toner after the toner was left in an environment at 160° C. for 24 hours was 0.5×10⁴ Pas. The number of sheets of paper fed when damage occurred in the heat roller was 500×10³.

### Comparative Example 7

A toner of Comparative Example 7 was produced in the same manner as in Example 1 except that the composition of the toner raw materials was changed as follows.

| | |
|---|---|
| amorphous polyester resin A1 | 63 parts |
| amorphous polyester resin B1 | 17 parts |
| crystalline polyester resin C1 | 10 parts |
| ester wax | 5 parts |
| carbon black | 5 parts |

The temperature at which low-temperature offset occurred was 121° C. The temperature at which high-temperature offset occurred was 185° C. The viscosity of the toner after the toner was left in an environment at 160° C. for 24 hours was 0.7×10⁴ Pa·s. The number of sheets of paper fed when damage occurred in the heat roller was 470×10³.

### Comparative Example 8

A toner of Comparative Example 8 was produced in the same manner as in Example 1 except that the composition of the toner raw materials was changed as follows.

| | |
|---|---|
| amorphous polyester resin A1 | 48 parts |
| amorphous polyester resin B1 | 32 parts |
| crystalline polyester resin C1 | 10 parts |
| ester wax | 5 parts |
| carbon black | 5 parts |

The temperature at which low-temperature offset occurred was 142° C. The temperature at which high-temperature offset occurred was 213° C. The viscosity of the toner after the toner was left in an environment at 160° C. for 24 hours was 2.5×10⁴ Pas. The number of sheets of paper fed when damage occurred in the heat roller was 80×10³.

The evaluation results of Examples 1 to 7 and Comparative Examples 1 to 8 are shown in Table 1.

TABLE 1

| | Offset resistance | | | | |
|---|---|---|---|---|---|
| | Low- | High- | | | |
| | temperature | temperature | | | |
| | offset | offset | Evaluation | Heat roller life | |
| | resistance | resistance | of viscosity | performance | Determination |
| Example 1 | fair | fair | good | fair | good |
| Example 2 | good | fair | good | good | good |
| Example 3 | fair | good | good | fair | good |
| Example 4 | good | fair | good | fair | good |
| Example 5 | fair | good | good | fair | good |
| Example 6 | fair | fair | good | good | good |
| Example 7 | fair | fair | good | fair | good |
| Comparative Example 1 | good | poor | good | fair | poor |
| Comparative Example 2 | poor | fair | poor | poor | poor |
| Comparative Example 3 | poor | good | poor | poor | poor |
| Comparative Example 4 | fair | poor | good | good | poor |
| Comparative Example 5 | poor | good | poor | poor | poor |
| Comparative Example 6 | fair | poor | good | good | poor |
| Comparative Example 7 | fair | poor | good | good | poor |
| Comparative Example 8 | poor | good | poor | poor | poor |

In the column of determination in Table 1, a toner in which there was not a single item evaluated as poor among the evaluation items of low-temperature offset resistance, high-temperature offset resistance, viscosity, and heat roller life performance was evaluated as “good”. Further, a toner in which there was even a single item evaluated as poor among the evaluation items of low-temperature offset resistance, high-temperature offset resistance, viscosity, and heat roller life performance was evaluated as “poor”.

As shown in Table 1, the toners of Examples 1 to 7 had excellent heat roller life performance, low-temperature offset resistance, and high-temperature offset resistance.

In Comparative Example 1, the Mw_{A}, Mn_{A}, and Mw_{A}/Mn_{A} are larger than those of Examples 1 to 7. In Comparative Example 1, the high-temperature offset resistance was insufficient.

In Comparative Example 2, the Mw_{A} and Mn_{A} are larger than those of Examples 1 to 7. In Comparative Example 2, the low-temperature offset resistance and the heat roller life performance were insufficient.

In Comparative Example 3, the Mw_{B} and Mn_{B} are larger than those of Examples 1 to 7. In Comparative Example 3, the low-temperature offset resistance and the heat roller life performance were insufficient.

In Comparative Example 4, the Mw_{B} and Mn_{B} are smaller than those of Examples 1 to 7. In Comparative Example 4, the high-temperature offset resistance was insufficient.

In Comparative Example 5, the content of the amorphous polyester resin A is smaller than that of Examples 1 to 7. Further, the content of the amorphous polyester resin B is larger than that of Examples 1 to 7. In Comparative Example 5, the low-temperature offset resistance and the heat roller life performance were insufficient.

In Comparative Example 6, the content of the amorphous polyester resin A is larger than that of Examples 1 to 7. Further, the content of the amorphous polyester resin B is smaller than that of Examples 1 to 7. In Comparative Example 6, the high-temperature offset resistance was insufficient.

In Comparative Example 7, the content of the amorphous polyester resin A is larger than that of Examples 1 to 7. Further, the content of the amorphous polyester resin B is smaller than that of Examples 1 to 7. In Comparative Example 7, the high-temperature offset resistance was insufficient.

In Comparative Example 8, the content of the amorphous polyester resin A is smaller than that of Examples 1 to 7. Further, the content of the amorphous polyester resin B is larger than that of Examples 1 to 7. In Comparative Example 8, the low-temperature offset resistance and the heat roller life performance were insufficient.

While certain embodiments of the invention have been described, these embodiments have been presented by way of example only, and are not intended to limit the scope of the invention. The embodiments described herein may be embodied in various other forms, and various omissions, substitutions, and changes may be made without departing from the gist of the invention. The embodiments and modifications thereof are included in the scope and gist of the invention and also included in the invention described in the claims and in the scope of their equivalents.

1. A toner comprising:
a colorant;
an amorphous polyester resin A having a mass average molecular weight of (Mw_{A}) of from 0.9×10⁴ to 1.5×10⁴; and
an amorphous polyester resin B having a mass average molecular weight (Mw_{B}) of from 4.0×10⁴ to 11.0×10⁴, wherein
the amorphous polyester resin A has a number average molecular weight (Mn_{A}) of from 3.0×10³ to 4.0×10³,
the amorphous polyester resin A has a molecular weight distribution (Mw_{A}/Mn_{A}) of from 3.1 to 4.0,
the amorphous polyester resin B has a number average molecular weight (Mn_{B}) of from 2.2×10³ to 3.5×10³,
the amorphous polyester resin B has a molecular weight distribution (Mw_{B}/Mn_{B}) of from 11.4 to 50,
the content of the amorphous polyester resin A is from 50 to 60 mass % with respect to 100 mass % of the total amount of the toner, and
the content of the amorphous polyester resin B is from 20 to 30 mass % with respect to 100 mass % of the total amount of the toner,
wherein Mw_{A}, Mw_{B} Mn_{A} and Mn_{B} are measured by GPC under the conditions described in the specification, and the molecular weight is calculated based on a calibration curve prepared in advance using polyethylene glycol as a reference material.

2. The toner according to claim 1, further comprising a crystalline polyester resin C.

3. The toner according to claim 2, wherein the content of the crystalline polyester resin C is from 3 to 20 mass % with respect to 100 mass % of the total amount of the toner.

4. The toner according to claim 1, wherein the colorant comprises carbon black, cyan, yellow, or magenta-based pigments.

5. The toner according to claim 1, wherein the colorant comprises carbon black, cyan, yellow, or magenta-based dyes.

6. The toner according to claim 1, wherein the amorphous polyester resin A has the mass average molecular weight (Mw_{A}) of 1.1×10⁴ to 1.4×10⁴.

7. The toner according to claim 1, wherein the amorphous polyester resin A has the number average molecular weight (Mn_{A}) of 3.2×10³ to 3.8×10³.

8. The toner according to claim 1, wherein the amorphous polyester resin A has the molecular weight distribution (Mw_{A}/Mn_{A}) of 3.2 to 3.7.

9. The toner according to claim 1, wherein the amorphous polyester resin A has a glass transition temperature of from 50° C. to 70° C.

10. The toner according to claim 1, wherein the amorphous polyester resin B has the mass average molecular weight (Mw_{B}) of 4.5×10⁴ to 9.0×10⁴.

11. The toner according to claim 1, wherein the amorphous polyester resin B has the number average molecular weight (Mn_{B}) of 2.5×10³ to 3.1×10³.

12. The toner according to claim 1, wherein the amorphous polyester resin B has the molecular weight distribution (Mw_{B}/Mn_{B}) of 14.5 to 36.

13. The toner according to claim 1, wherein the amorphous polyester resin B has a glass transition temperature of from 45° C. to 65° C.

14. The toner according to claim 3, wherein the crystalline polyester resin C is a polyester resin in which the ratio of the softening point to the melting temperature is from 0.8 to 1.2.

15. The toner according to claim 1, wherein the content of the colorant is from 3 to 10 mass % with respect to 100 mass % of the total amount of the toner.

16. A toner cartridge comprising a container comprising the toner according to claim 1.

17. An image forming apparatus comprising the toner cartridge according to claim 16.

18. A toner comprising:
a colorant;
an amorphous polyester resin A having a mass average molecular weight (Mw_{A}) of from 0.9×10⁴ to 1.5×10⁴; and
an amorphous polyester resin B having a mass average molecular weight (Mw_{B}) of from 4.0×10⁴ to 11.0×10⁴, wherein
the amorphous polyester resin A has a number average molecular weight (Mn_{A}) of from 3.0×10³ to 4.0×10³,
the amorphous polyester resin A has a molecular weight distribution (Mw_{A}/Mn_{A}) of from 3.1 to 4.0,
the amorphous polyester resin B has a number average molecular weight (Mn_{B}) of from 2.2×10³ to 3.5×10³,
the amorphous polyester resin B has a molecular weight distribution (Mw_{B}/Mn_{B}) of from 11.4 to 50,
the content of the amorphous polyester resin A is from 50 to 60 mass % with respect to 100 mass % of the total amount of the toner, and
the content of the amorphous polyester resin B is from 20 to 30 mass % with respect to 100 mass % of the total amount of the toner,
wherein a viscosity of the toner after the toner was left in an environment at 160° C. for 24 hours was 1.0×10⁴ Pa·s or less that are measured under the conditions described in the specification.
